(19) United States
(12) Patent Application Publication
(10) Pub. No.: US 2015/0325835 A1
(43) Pub. Date: Nov. 12, 2015

(54) JET NOZZLE, JET PROCESSING DEVICE, PROCESSING METHOD, METHOD FOR MANUFACTURING CELL COMPONENT, AND SECONDARY CELL

(71) Applicant: NIKON CORPORATION, Tokyo (JP)

(72) Inventors: Mohammad Saeed SEPASY ZAHMATY, Sendai (JP); Tatsuya SEKIMOTO, lwanuma (JP)

(73) Assignee: NIKON CORPORATION, Tokyo (JP)

(21) Appl. No.: 14/801,321

(22) Filed: Jul. 16, 2015

Related U.S. Application Data
(63) Continuation of application No. PCT/JP2014/050689, filed on Jan. 16, 2014.

(30) Foreign Application Priority Data
Jan. 17, 2013 (JP) 2013-006576
Jul. 26, 2013 (JP) 2013-155603

(51) Int. Cl. H01M 4/04; H01M 10/0525; B05D 1/02; B05B 7/14

(52) U.S. Cl. CPC H01M 4/0419; B05B 7/1486; H01M 10/0525; B05D 1/02

(57) ABSTRACT

A jet nozzle includes: a jet opening through which a fluid mixture of particles and gas is jetted; a first flow channel extending along a first direction to the jet opening; a flow diverging region located in the first flow channel at opposite the jet opening and comprises a plurality of flow diverging channels arranged in a direction intersecting with the first direction; a second flow channel that makes the particles join in the flow diverging region in a second direction which is at a predetermined angle to the first direction; and a third flow channel through which the gas is jetted to the first flow channel.

This application is a continuation of International Application No. PCT/JP2014/050689 filed on Jan. 16, 2014.

### INCORPORATION BY REFERENCE

The disclosures of the following priority applications and the International Application are herein incorporated by reference:

Japanese Patent Application No. 2013-006576 filed on Jan. 17, 2013;
Japanese Patent Application No. 2013-155603 filed on Jul. 26, 2013; and International Application No. PCT/JP2014/050689 filed on Jan. 16, 2014.

### BACKGROUND OF THE INVENTION

1. Field of the Invention

The present invention relates to a jet nozzle, a jet processing device, a processing method, a method for manufacturing a cell component, and a secondary cell.

2. Description of Related Art

A particle jet nozzle that jets particles within a guide block provided inside the nozzle in order to jet the particles from a slit-shaped wide jetport to achieve uniform jetting of the particles in a lengthwise direction of the jet port has been conventionally known (see Laid-Open Japanese Patent Publication No. 11-333725).

### SUMMARY OF THE INVENTION

The present invention provides a jet nozzle of a new structure capable of jetting (spraying) the particles uniformly in the lengthwise direction of the jet port.

According to the first aspect of the present invention, a jet nozzle comprises: a jet opening through which a fluid mixture of particles and gas is jetted; a first flow channel extending along a first direction to the jet opening; a flow diverging region located in the first flow channel at opposite the jet opening and comprises a plurality of flow diverging channels arranged in a direction intersecting with the first direction; a second flow channel that makes the particles join in the flow diverging region in a second direction which is at a predetermined angle to the first direction; and a third flow channel through which the gas is jetted to the first flow channel.

According to the second aspect of the present invention, in the jet nozzle according to the first aspect, it can be that the jet nozzle further comprises: a particle introduction opening through which the particles are introduced; and a gas introduction opening through which the gas for accelerating the particles is introduced, wherein: the first flow channel comprises a wide wall surface, which is a wall surface including a longitudinal direction of a flow channel section perpendicular to the first direction, and a narrow wall surface which is a wall surface including a direction intersecting with the longitudinal direction; the second flow channel makes the particles, which are introduced from the particle introduction opening, join in the flow diverging region; and the third flow channel jets the gas, which is introduced from the gas introduction opening, through an acceleration gas confluence opening towards the first flow channel.

According to the third aspect of the present invention, in the jet nozzle according to the second aspect, it can be that a plural number of the acceleration gas confluence opening is arranged to intersect with the first direction.

According to the fourth aspect of the present invention, in the jet nozzle according to the second or third aspect, it can be that the acceleration gas confluence opening is provided near the flow diverging region.

According to the fifth aspect of the present invention, in the jet nozzle according to any one of the second through fourth aspects, it can be that the acceleration gas confluence opening is provided corresponding to each of the plurality of flow diverging channels.

According to the sixth aspect of the present invention, in the jet nozzle according to any one of the second through fifth aspects, it can be that the particles introduced from the second flow channel join in the first flow channel through a particle confluence opening; and the flow diverging region is provided in the vicinity of the particle confluence opening.

According to the seventh aspect of the present invention, in the jet nozzle according to any one of the third through sixth aspects, it can be that the plurality of flow diverging channels are arranged linearly in a direction perpendicular to the first direction.

According to the eighth aspect of the present invention, in the jet nozzle according to any one of the second through seventh aspects, it can be that a plurality of salient portions having a width in a direction intersecting with the first direction and protruding from the wide wall surface are arranged in a direction intersecting with the first direction in the flow diverging region; and each of the plurality of flow diverging channels extends between the salient portions.

According to the ninth aspect of the present invention, in the jet nozzle according to the eighth aspect, it can be that the plurality of salient portions are ones which the particles flowing from the second flow channel collide with and diverge at.

According to the tenth aspect of the present invention, in the jet nozzle according to any one of the second through ninth aspects, it can be that the acceleration gas confluence opening introduces the gas and causes an ejector effect to make the particles drawn from the second flow channel into the first flow channel.

According to the eleventh aspect of the present invention, in the jet nozzle according to any one of the second through tenth aspects, it can be that the particle introduction opening has a rectangular shape with a longitudinal direction and a transverse direction; and a length of the longitudinal direction of the jet opening is predetermined times as long as a length of the transverse direction of the particle introduction opening.

According to the twelfth aspect of the present invention, in the jet nozzle according to any one of the second through eleventh aspects, it can be that the predetermined angle is larger than 90 degrees.

According to the thirteenth aspect of the present invention, a jet processing device comprises: the jet nozzle according to any one of the second through twelfth aspects; and a particle supply unit that supplies the particles via the particle introduction opening to the second flow channel of the jet nozzle.

According to the fourteenth aspect of the present invention, a processing method comprises: jetting the fluid mixture of the particles and the gas from the jet opening of the jet nozzle in the jet processing device according to claim 13; and making the particles collide with a substrate located opposite the jet opening.

According to the fifteenth aspect of the present invention, a cell component manufacturing method comprises: making the particles collide with an electrode substrate provided as the substrate by the processing method according to claim 14; and forming an electrode material film on the electrode substrate.

According to the sixteenth aspect of the present invention, a secondary cell comprises the electrode material film manufactured by the cell material manufacturing method according to claim 15 on an electrode.

According to the present invention, provided is a jet nozzle of a new structure capable of dispersing and jetting the particles substantially uniformly by distributing particles, flew from a second direction at a predetermined angle relative to a first direction, at a flow diverging region provided in a first flow channel.

### BRIEF DESCRIPTION OF THE DRAWINGS

FIG. 1A is a schematic figure illustrating the structure of a jet processing device according to an embodiment of the present invention and FIG. 1B is an external perspective view of the jet nozzle constituting the jet processing device.

FIG. 2 is a figure illustrating flow channels of the jet nozzle according to the first embodiment as taken along cross section A-A in FIG. 1B.

FIG. 3 is a figure illustrating the flow channels of the jet nozzle according to the first embodiment as taken along cross section B-B in FIG. 1B.

FIG. 4A and FIG. 4B are perspective views illustrating the flow channels of the jet nozzle according to the first embodiment.

FIG. 5 is a figure illustrating simulation results of a flow rate of a fluid mixture jetted from a jet port in Example 2.

FIG. 6 is a figure explaining a film thickness and deposition width of a film formed with solid particles jetted from the jet port in Example 2.

FIG. 7 is a figure illustrating flow channels of a jet nozzle according to a second embodiment as taken along cross section A-A in FIG. 1B.

FIG. 8 is a perspective view illustrating the flow channels of the jet nozzle according to the second embodiment.

FIG. 9A to FIG. 9K are figures illustrating flow channels of jet nozzles according to variations as taken along cross section A-A in FIG. 1B.

FIG. 10 is a figure illustrating flow channels of a jet nozzle according to a variation as taken along across section A-A in FIG. 1B.

FIG. 11 is a figure illustrating the shape of a jet opening of a jet nozzle according to a variation.

FIG. 12A to FIG. 12D are an external view and parts assembly figures of a jet nozzle in Example 1.

FIG. 13A to FIG. 13E are figures explaining the flow channels of the jet nozzle in Example 1.

FIG. 14 is a figure explaining a film thickness and deposition width of a film formed with solid particles jetted from a jet port in Example 1.

FIG. 15 is a flowchart explaining a jet processing method.

FIG. 16 is a flowchart explaining a cell component manufacturing method.

FIG. 17 is a schematic configuration figure of a secondary cell including an electrode material film, which is manufactured by the cell component manufacturing method, as an electrode.

### DESCRIPTION OF EMBODIMENTS

A jet nozzle according to an embodiment of the present invention is configured so that a fluid mixture is flew obliquely into a plurality of flow diverging channels provided and arranged along a direction intersecting with a predetermined jetting direction. Because of this structure, the jet nozzle according to the embodiment of the present invention realizes expansion of the width of the flow channel and uniform distribution of particles. Furthermore, the jet nozzle according to the embodiment of the present invention further introduces acceleration gas, thereby sufficiently dispersing the particles through a jetting path and jetting the particles uniformly from a jet opening. The detailed explanation will be give below.

### First Embodiment

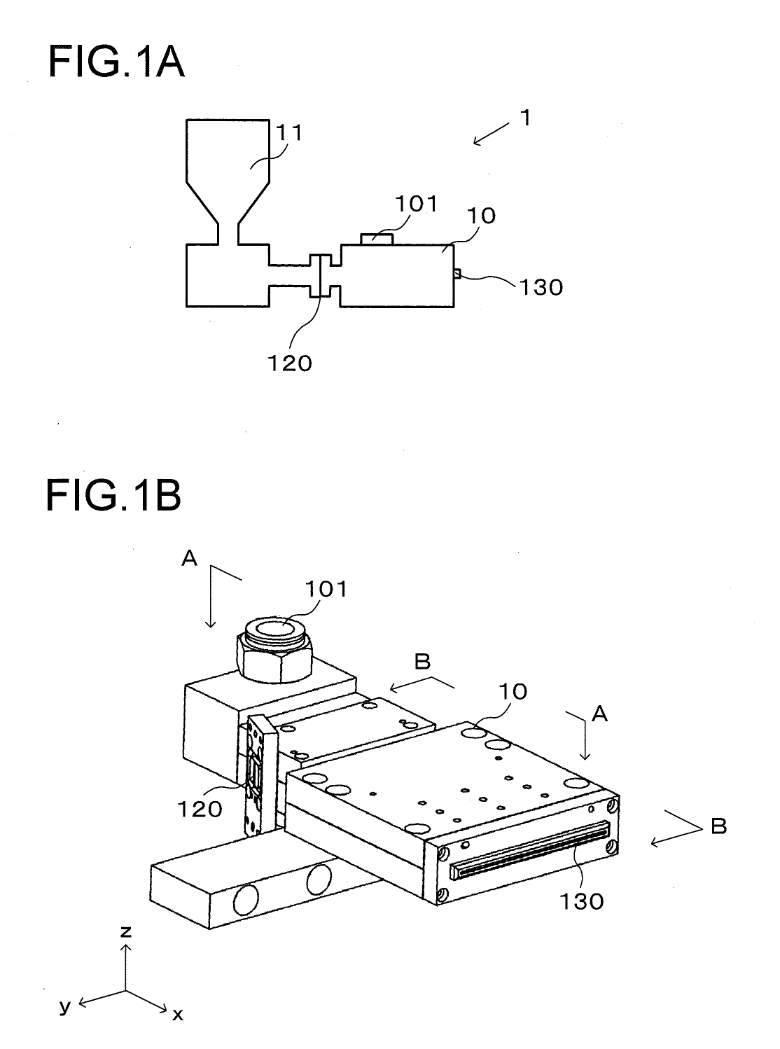

A jet processing device according to a first embodiment of the present invention will be explained with reference to drawings. FIG. 1A is a schematic configuration figure illustrating the configuration of a jet processing device 1 according to the first embodiment. The jet processing device 1 is configured by including a solid particle supply unit 11 that contains solid particles and supplies them to a jet nozzle; and the jet nozzle 10 which the solid particle supply unit 11 can be attached to or detached from. Examples of the solid particles include particles of various metals such as gold, silver, copper, aluminum, tin, nickel, and titanium, and the like, particles of various alloys, such as Si—Cu alloy and Si—Sn alloy, and intermetallic compounds, particles of ceramics such as aluminum oxide and zirconium oxide, and the like and various inorganic glass materials, and particles of polymer compounds such as polyethylene, and the like. Also, composite particles made by combining different kinds of materials by, for example, a mechanical alloying method and coated particles made by surface coating of different kinds of materials can be used.

FIG. 1B is an external perspective view of the jet nozzle 10. To make it easily understandable, FIG. 1B shows a state in which the solid particle supply unit 11 is not connected to the jet nozzle 10. The jet nozzle 10 is provided with a gas introduction opening 101, a particle introduction opening 120, and a jet opening 130. The solid particle supply unit 11 is connected to the jet nozzle 10 via the particle introduction opening 120.

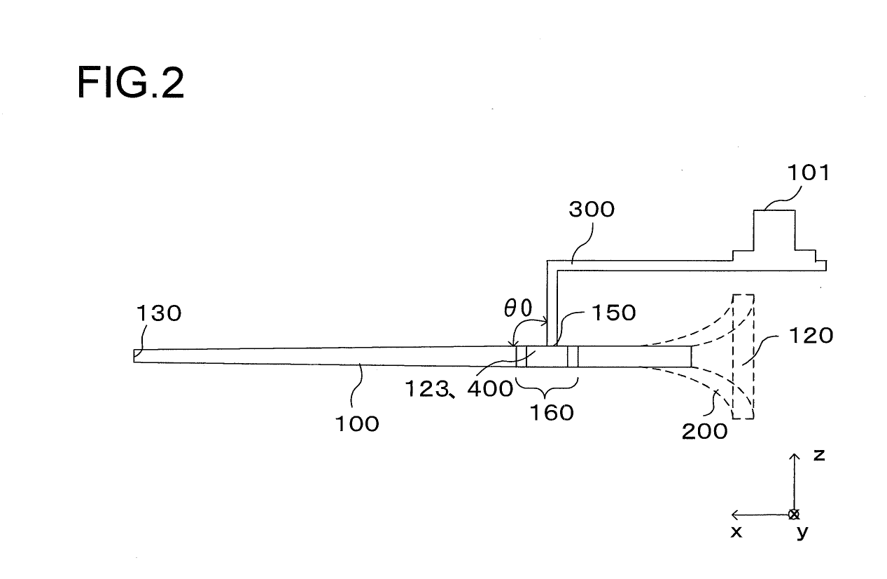

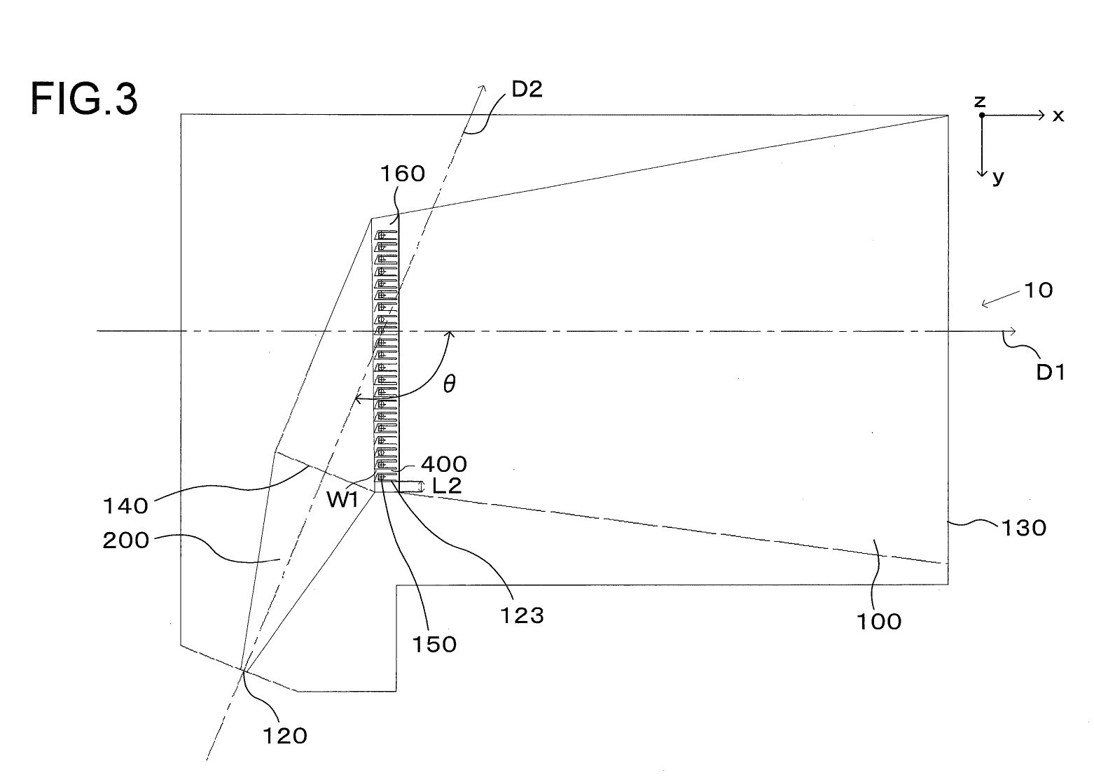

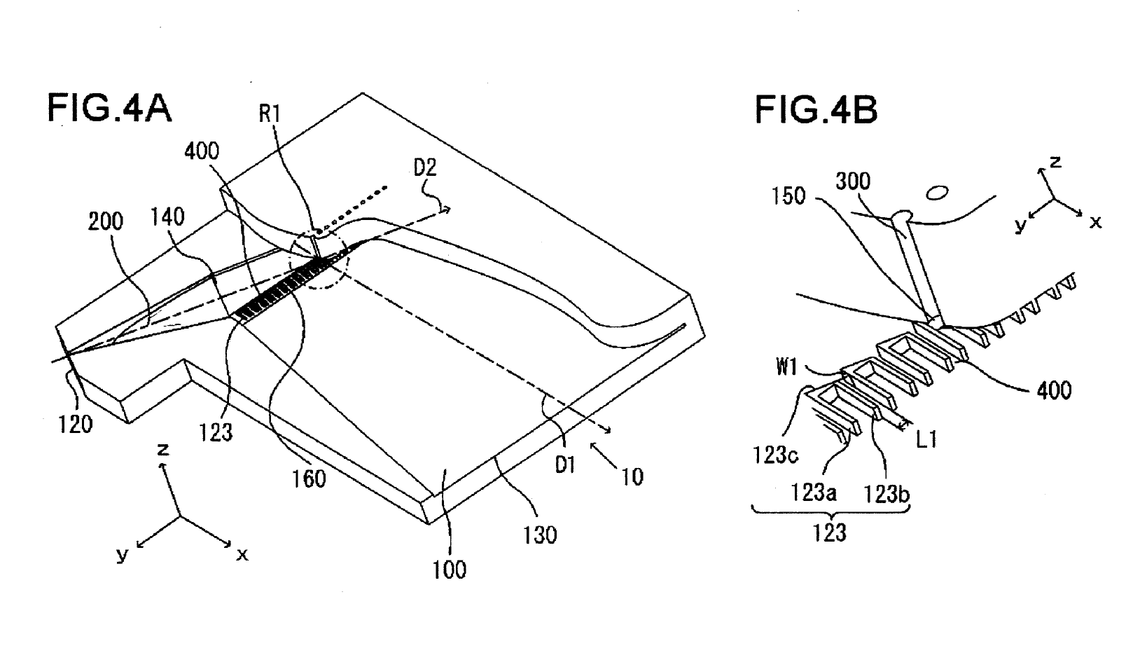

FIG. 2 is a cross-sectional view of flow channels provided within the jet nozzle 10 as taken along line A-A in FIG. 1B; and FIG. 3 is a cross-sectional view of the jet nozzle 10 as taken along line B-B in FIG. 1B. Incidentally, for the convenience of explanation, FIG. 2 schematically illustrates a cross-section of the flow channels as viewed from a y-axis negative side. FIG. 4A and FIG. 4B are perspective views of the flow channels inside the jet nozzle 10 illustrated in FIG. 1A and FIG. 1B; and FIG. 4B is an enlarged view of region R1 enclosed by dashed dotted line in FIG. 4A. Incidentally, for the convenience of explanation, coordinate system represented by the x-axis, the y-axis, and the z-axis are set as illustrated in FIG. 1A, FIG. 1B, FIG. 2, FIG. 3, FIG. 4A, and FIG. 4B.

The flow channels for jetting solid particles are formed in the jet nozzle 10 as illustrated in FIG. 2, FIG. 3, FIG. 4A, and FIG. 4B. The flow channels of the jet nozzle 10 are composed of a first flow channel 100, a second flow channel 200, and a third flow channel 300. The first flow channel 100 functions as a jetting path that promotes diffusion of the solid particles in the fluid mixture and jets the fluid mixture from the jet opening 130. Incidentally, for the convenience of explanation in the present specification, the x-axis is set along a jetting direction D1. The second flow channel 200 functions as a particle supply channel. The third flow channel 300 functions as a gas introduction channel for introducing acceleration gas.

In the jet processing device 1 according to the present embodiment, the solid particles supplied from the solid particle supply unit 11 via the particle introduction opening 120 are dispersed, diffused, and accelerated by an effect caused by the shapes of the flow channels of the jet nozzle 10, an effect caused by the gas supplied from the gas introduction opening 101 through the third flow channel 300, and an effect caused by a flow diverging region 160. The fluid mixture of the solid particles and the gas is jetted from the jet opening 130 at a terminal end of the first flow channel 100 towards, for example, a surface of an electrode to be processed.

The jet nozzle 10 is manufactured by using anti-corrosive materials such as, for example, ceramics such as alumina, silicon nitride, or the like, or hard metals made by mixing and sintering tungsten carbide and cobalt, or the like. The gas introduction opening 101 is connected via, for example, tubes to a gas supply source (not shown in the drawing) such as a gas cylinder. The gas introduction opening 101 is configured so that the pressure of various kinds of gases such as He, N₂, Ar, and air (acceleration gas) are adjusted to a desired pressure and then supplied.

The first flow channel 100 extends along the jetting direction D1 to the jet opening 130 and its flow channel section taken along a plane perpendicular to the jetting direction D1 is of a flat shape within the width along the y-axis direction is wide and the width along the z-axis direction is narrow. In the present specification, a wall surface with the wide width along the y-axis direction will be referred to as the wide wall surface and a wall surface with the narrow width along the z-axis direction will be referred to as the narrow wall surface. FIGS. 2 to 4 illustrate a case in which the flow channel section taken along the plane perpendicular to the x-axis of the first flow channel 100 is of a rectangular shape as an example; however, the shape of the flow channel section is not limited to the rectangular shape and various shapes such as oval or ellipse can be used as a flat shape. A cross-section area along the plane perpendicular to the x-axis of the first flow channel 100 is formed to continuously increase from the x-axis negative side towards the jet opening 130. In the present embodiment as illustrated in FIGS. 2 to 4, the y-axis direction length of the flow channel section of the first flow channel 100 continuously increases equally in the y-axis positive direction and negative direction and the y-axis direction length of the flow channel section becomes longest at the jet opening 130. Furthermore, the z-axis direction length of the flow channel section of the first flow channel 100 continuously decreases from the x-axis negative side towards the jet opening 130 and the z-axis direction length becomes shortest at the jet opening 130. A ratio of the z-axis direction length to the y-axis direction length of the jet opening 130, that is, an aspect ratio of the jet opening 130 is, for example, approximately 0.001 to 0.1 and may be approximately 0.005 to 0.05. The jet opening 130 with the aspect ratio within the range of 0.01±0.005 is one of typical examples of the jet opening 130. The flow diverging region 160 is provided on the side (upstream side) opposite the jet opening 130 of the first flow channel 100 in along a direction intersecting with the jetting direction D1. The details of the flow diverging region 160 will be explained later.

A particle confluence opening 140 is opened on the x-axis negative side of the narrow wall surface defining the first flow channel 100. The second flow channel 200 extends along a confluence direction D2 and supplies the solid particles from the particle confluence opening 140 towards the flow diverging region 160 in the confluence direction D2. Incidentally, the jet nozzle 10 is configured so that the angle θ formed by the jetting direction D1 and the confluence direction D2 is to be larger than 90 degrees and smaller than 180 degrees. A preferred range of θ is 95 degrees≦θ≦175 degrees, more preferably 100 degrees≦θ≦135 degrees. On the wide wall surface which defines the first flow channel 100, acceleration gas confluence openings 150 are provided between the particle confluence opening 140 and the jet opening 130 relative to the x-axis direction, and the first flow channel 100 is connected to the third flow channel 300 whose details will be described later via the gas for acceleration confluence openings 150. The flow diverging region 160 including a plurality of flow diverging channels 400 whose details will be described later is provided in the first flow channel 100 between the particle confluence opening 140 and the jet opening 130 relative to the x-axis direction along the direction intersecting with the jetting direction D1.

Incidentally, instead of the first flow channel 100 in which the cross-section area thereof along the plane perpendicular to the jetting direction D gradually and continuously increases towards the jet opening 130, a structure having the same cross-section area along the plane perpendicular to the jetting direction D may be used. Furthermore, instead of the flow channel section of the first flow channel 100 whose y-axis direction length, that is, its long-side length continuously increases to both the y-axis positive direction and the y-axis negative direction, the flow channel section of the first flow channel 100 whose y-axis direction length continuously increases to either the y-axis positive direction or to the y-axis negative direction may be used. Instead of the first flow channel 100 in which the cross-section area thereof in the flat plane perpendicular to the jetting direction D1 continuously increases towards the jet opening 130, the cross-section area of the first flow channel 100 increases in a stepwise manner may be used. However, even in each of the above-mentioned cases, the longitudinal direction length of the jet opening 130 is configured to be longer than the transverse direction length of the particle introduction opening 120, that is, the longitudinal direction length of the jet opening 130 is configured to be larger than one time of the transverse direction length of the particle introduction opening 120.

The second flow channel 200 extends along the confluence direction D2. The particle introduction opening 120 is a connection part for introducing the solid particles from the solid particle supply unit 11 to the jet nozzle 10. The particle introduction opening 120 is of a rectangular shape. Incidentally, the drawings illustrate the particle introduction opening 120 as a rectangular shape whose long side is in the z-axis direction; however, the direction of the long side is not limited to this example. Moreover, the shape of the particle introduction opening 120 is not limited to the rectangular and various shapes such as an oval or an ellipse are possible. The solid particle supply unit 11 supplies a predetermined amount of solid particles together with carrier gas to the jet nozzle 10. Various gases can be used as the carrier gas just like the aforementioned acceleration gas.

A flow channel section taken along a plane perpendicular to the confluence direction D2 of the second flow channel 200 is of a rectangular shape and its cross-sectional shape is formed so as to change along the confluence direction D2 from the particle introduction opening 120 to the particle confluence opening 140. Specifically, the shape of the flow channel section taken along the plane perpendicular to the confluence direction D2 of the second flow channel 200 is formed so that the cross-sectional area remains constant and a ratio of the long side to the short side continuously changes. Namely, the shape of the flow channel section is formed to gradually change so that the section taken along the plane perpendicular to the confluence direction D2 of the second flow channel 200 is of a rectangular shape, for which the z-axis direction is its long side, on the side of the particle introduction opening 120 and is of a rectangular shape, for which the z-axis direction is its short side, on the side of the particle confluence opening 140. Incidentally, the shape of the flow channel section of the second flow channel 200 is not limited to the rectangular shape and various shapes such as an oval or an ellipse are possible. Moreover, the shape of the flow channel section taken along the plane perpendicular to the confluence direction D2 of the second flow channel 200 is not limited to any shape that changes along the confluence direction D2, and the flow channel section does not change is also included as an embodiment of the present invention. Even when the shape of the flow channel section changes, the flow channel section is not limited to such a flow channel section whose cross-sectional area remains constant and whose shape changes; and the flow channel section changes continuously or changes in a stepped manner is also included as an embodiment of the present invention. Furthermore, the second flow channel 200 is not limited to the second flow channel 200 that extends along the confluence direction D2. Without depending on the path from the particle introduction opening 120, a channel that supplies the solid particles in the confluence direction D2 towards the flow diverging region 160 is included as an embodiment of the present invention.

The first flow channel 100 is provided with the flow diverging region 160 along a direction intersecting with the jetting direction D1. FIG. 3 illustrates an example in which the flow diverging region 160 is provided in contact with an end portion of the particle confluence opening 140 on its side of the jet opening 130 and along a direction perpendicular to the x-axis, that is, along the y-axis direction. Incidentally, the flow diverging region 160 is not limited to that provided in the example illustrated in FIG. 3; and the flow diverging region 160 may be provided near the particle confluence opening 140 and any embodiment of the flow diverging region 160 provided between the particle confluence opening 140 and the jet opening 130 is included in the present invention.

The plurality of flow diverging channels 400 are arranged in the flow diverging region 160 along a direction intersecting with the jetting direction D1. In this embodiment, a plurality of flow diverging channels are formed between salient portions 123. Each salient portion 123 includes wall portions 123a and 123b and a connecting wall portion 123c for connecting the wall portions 123a and 123b. The wall portions 123a and 123b and the connecting wall portion 123c protrude from one wide wall surface of the first flow channel 100 in the z-axis direction so as to reach the other opposite wide wall surface of the first flow channel 100. The wall portions 123a and 123b extend in the jetting direction D1 and the connecting wall portion 123c extends along the confluence direction D2. The salient portion 123 is an “U-shaped” in a cross-section parallel to the xy plane as illustrated in FIG. 3, FIG. 4A, and FIG. 4B. The plurality of salient portions 123 are arranged at a predetermined distance L1 (see FIG. 4B) along the y-axis direction.

Incidentally, it can be that when salient portions 123 are arranged at the distance L1 between them, distance L2 (see FIG. 3) between each of the salient portions 123, which located at both ends of the plurality of salient portions 123 arranged along the y-axis direction, and the narrow wall surface of the first flow channel 100 becomes larger than the aforementioned distance L1. The distance between the salient portions 123, the distance between the salient portion 123 and the narrow wall surface, the number of the salient portions 123 arranged, and so on are not limited to the aforementioned example and may be changed as necessary based on results of simulations and experiments.

The third flow channel 300 represents a flow channel from the gas introduction opening 101 to the gas for acceleration confluence opening 150 at which being connected to the first flow channel 100. Incidentally, FIG. 2 illustrates that angle θ0 formed by the third flow channel 300 and the first flow channel 100 is substantially 90 degrees; however, the present invention is not limited to this example. The third flow channel 300 can join at an appropriate angle into the first flow channel 100 depending on the shape of the jet nozzle 10. An advantageous effect of accelerating the solid particles is higher when angle θ0 is closer to 180 degrees; however, angle θ may be set as appropriate in consideration of, for example, designing limitations. The acceleration gas confluence opening 150 is provided on the wide wall surface defining the first flow channel 100 between the particle confluence opening 140 and the jet opening 130 relative to the x-axis. FIGS. 2 to 4 illustrate an example in which a plurality of acceleration gas confluence openings 150 are provided so that each acceleration gas confluence opening 150 corresponds to each of the plurality of salient portions 123 provided to protrude in the flow diverging region 160. Specifically, the acceleration gas confluence opening 150 is provided in an area surrounded by the wall portions 123a and 123b and the connecting wall portion 123c of the salient portion 123. Since the connecting wall portion 123c is provided on the x-axis negative side of the salient portion 123 as illustrated in FIG. 3, FIG. 4A, and FIG. 4B, the acceleration gas supplied from the acceleration gas confluence opening 150 spurts out towards the x-axis positive side. As the gas spurts out from the acceleration gas confluence opening 150 towards the x-axis positive side, a negative pressure is generated due to an ejector effect in the vicinity of the salient portions 123.

Incidentally, the acceleration gas confluence openings 150 are not limited to the examples illustrated in FIGS. 2 to 4. Instead of the acceleration gas confluence openings 150 provided in the flow diverging region 160, those provided in the vicinity of the flow diverging region 160, and for example, the acceleration gas confluence openings 150 provided between the particle confluence opening 140 and the jet opening 130 and arranged in a direction intersecting with the jetting direction D1 are also included as an embodiment of the present invention. Furthermore, the acceleration gas confluence openings 150 are not limited to those arranged in one wide wall surface, and those arranged in both wide wall surfaces which are opposite to each other is included as an embodiment of the present invention.

With the jet processing device 1 equipped with the jet nozzle 10 in which the aforementioned flow channels are formed, the fluid mixture of the solid particles and the gas which is supplied from the solid particle supply unit 11 is supplied via the particle introduction opening 120 to the second flow channel 200, flows in the confluence direction D2, passes through the particle confluence opening 140, and reaches the flow diverging region 160. A flowing direction of the fluid mixture of the solid particles and the gas which has reached the flow diverging region 160 changes from the confluence direction D2 to the jetting direction D1.

The solid particles are dispersed in the fluid mixture at the flow diverging region 160. Specifically, the solid particles which have advanced along the confluence direction D2 disperse by colliding with region W1 of the wall portions 123a constituting the salient portions 123 provided in the flow diverging region 160 (see FIG. 3, FIG. 4A, and FIG. 4B). Since the connecting wall portions 123c extend along the confluence direction D2, some of the solid particles which have reached the first flow channel 100 easily collide with the region W1 of the wall portions 123a of the salient portions 123; and as a result, the fluid mixture of the solid particles and the gas are easily dispersed.

Since the wall portions 123a and 123b that constitute the salient portions 123 protruding in the z-axis direction as described above are arranged along the jetting direction D1 and form the flow diverging channels 400 extending in the jetting direction D1, a travelling direction of the dispersed solid particles is generally aligned with the jetting direction D1. In other words, the salient portions 123 have a function dispersing the solid particles and a function aligning the flowing direction of the solid particles in the jetting direction D1. The fluid mixture of the dispersed solid particles and the gas passes between the wall portion 123a and the adjacent wall portion 123b of the salient portion 123, that is, passes through the flow diverging channel 400 and flows through the first flow channel 100 in the jetting direction D1.

The fluid mixture of the solid particles and the gas, which has been dispersed at the flow diverging channel 400 and whose flowing direction has been aligned as described above, is drawn in mainly by the negative pressure caused by the ejector effect of the gas from the acceleration gas confluence opening 150 and is accelerated in the jetting direction D1 (the x-axis positive direction) of the first flow channel 100. Specifically, when the acceleration gas is supplied at a predetermined pressure from the gas introduction opening 101 to the third flow channel 300, the acceleration gas spurts out from the acceleration gas confluence openings 150 formed in the flow diverging region 160 towards the jetting direction D1 (the x-axis positive direction), draws in and combines with the fluid mixture of the solid particles and the gas from the second flow channel 200, and flows through the first flow channel 100, and the fluid mixture of the solid particles and the gas is jetted via the jet opening 130 towards the electrode substrate.

A velocity of the solid particles jetted from the jet opening 130 is set mainly based on the kind and pressure of the acceleration gas. The solid particles in the fluid mixture jetted from the jet opening 130 collide with, and adheres to, the surface, to be adhered to, of the electrode substrate placed at a distance of 0.5 mm to 5 mm from the jet opening 130 in the x-axis direction. An electrode material film is formed on a surface of the electrode substrate at normal temperature and in normal pressure by relatively moving the jet nozzle 10 and the electrode substrate on the yz plane, while jetting the solid particles. When the y-axis direction length of the electrode substrate is longer than the y-axis direction length of the jet opening 130, film forming processing is executed by changing relative y-axis direction position of the jet opening 130 and the electrode substrate and relatively moving the jet nozzle 10 and the electrode substrate in the yz plane.

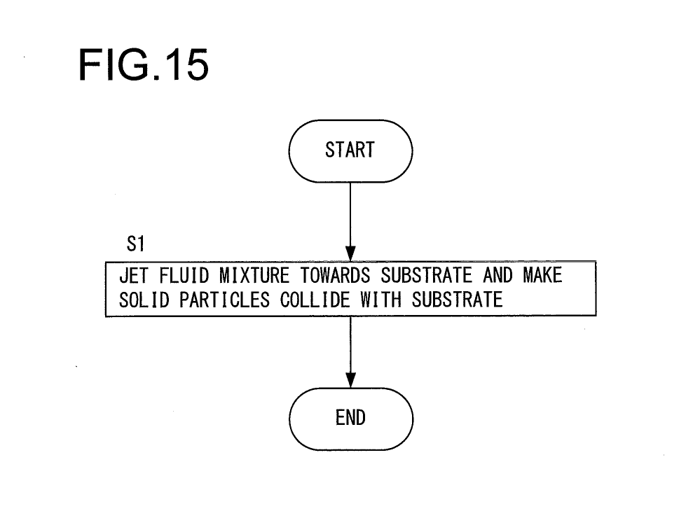

A processing method by using the jet processing device 1 will be explained with reference to a flowchart shown in FIG. 15. In step S1, the fluid mixture of the solid particles and the gas is jetted from the jet opening 130 towards the substrate and the solid particles are made to collide with the substrate placed opposite the jet opening 130, then the processing is terminated.

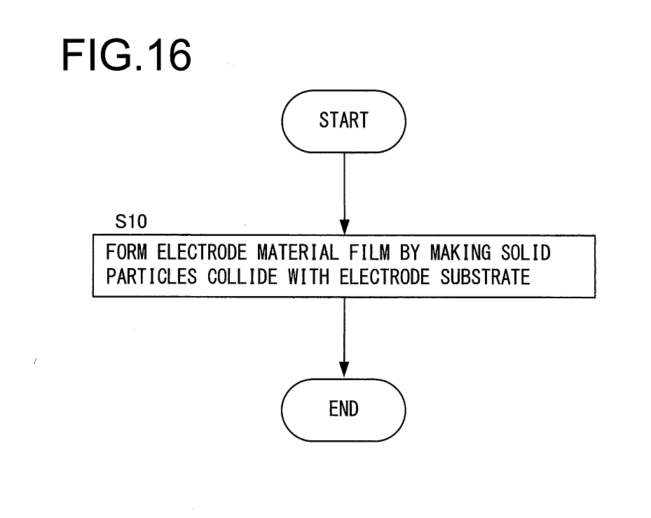

The electrode material film can be formed on the electrode substrate by a PJD (Powder Jet Deposition) method and, for example, negative electrode materials for a cell (battery) such as a lithium ion secondary cell can be formed by using the jet processing device 1 equipped with the jet nozzle 10 and the solid particle supply unit 11 as described above. In this case, for example, a conductive substrate such as copper (Cu) or conductive resin or the like as a material constituting a collector is used for the electrode substrate. A cell component manufacturing method will be explained with reference to a flowchart illustrated in FIG. 16. In step S10, the solid particles are made to collide with the electrode substrate and the electrode material film is formed by using the aforementioned electrode substrate by the same processing as the processing in step Si of the flowchart in FIG. 15, then the processing is terminated.

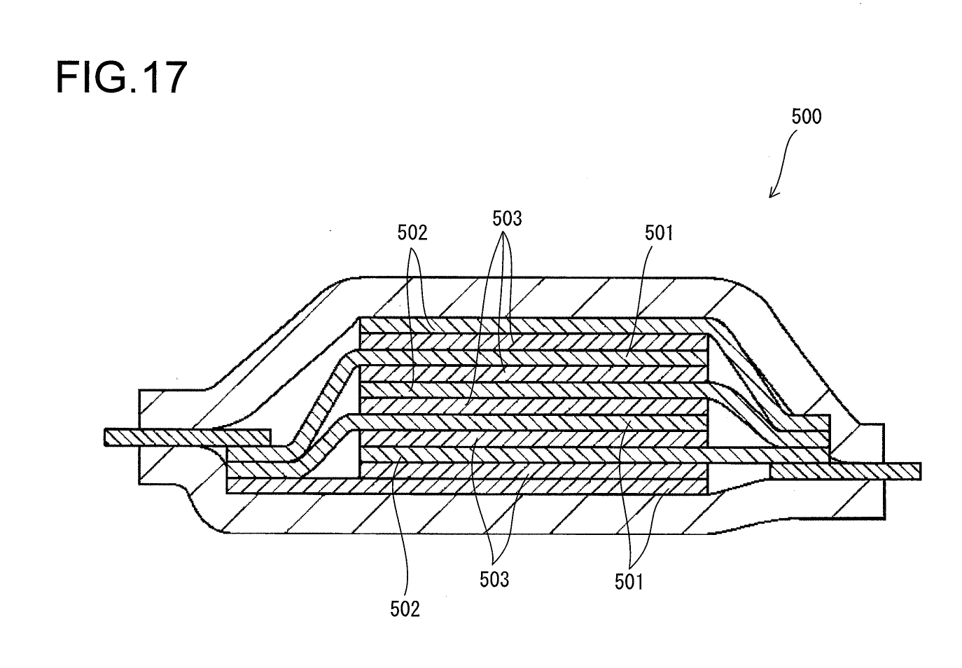

A negative electrode is formed by punching this electrode material and forming a shape of size according the shape of the cell (such as a cylinder, a rectangular, a cell-type, or a laminated type). FIG. 17 illustrates an example of a secondary cell including a cell component on which an electrode material film is formed by the above-described method. A lithium ion secondary cell 500 is configured by placing a known positive electrodes 501, which are obtained by forming a lithium transition metal oxide such as lithium cobalt oxide or the like as a positive electrode active material on an aluminum foil, and the above-described negative electrodes 502 facing each other, placing a separator 503 between each of the positive electrode 501 and each of the negative electrode 502, and encapsulating them together with a known electrolyte (nonaqueous electrolyte) in a known solvent. Incidentally, examples of the known solvent are propylene carbonate, ethylene carbonate and the like, and examples of the known electrolyte are LiClO₄, LiPF₆ and the like. As a result, a lithium ion secondary cell that can stably retain high electric capacity for a long period of time can be obtained. Incidentally, the jet processing device 1 may be used to form a positive electrode material instead of forming the negative electrode material for the lithium ion secondary cell. In this case, for example, a conductive substrate such as aluminum, conductive resin or the like may be used as the electrode substrate.

### Example 1

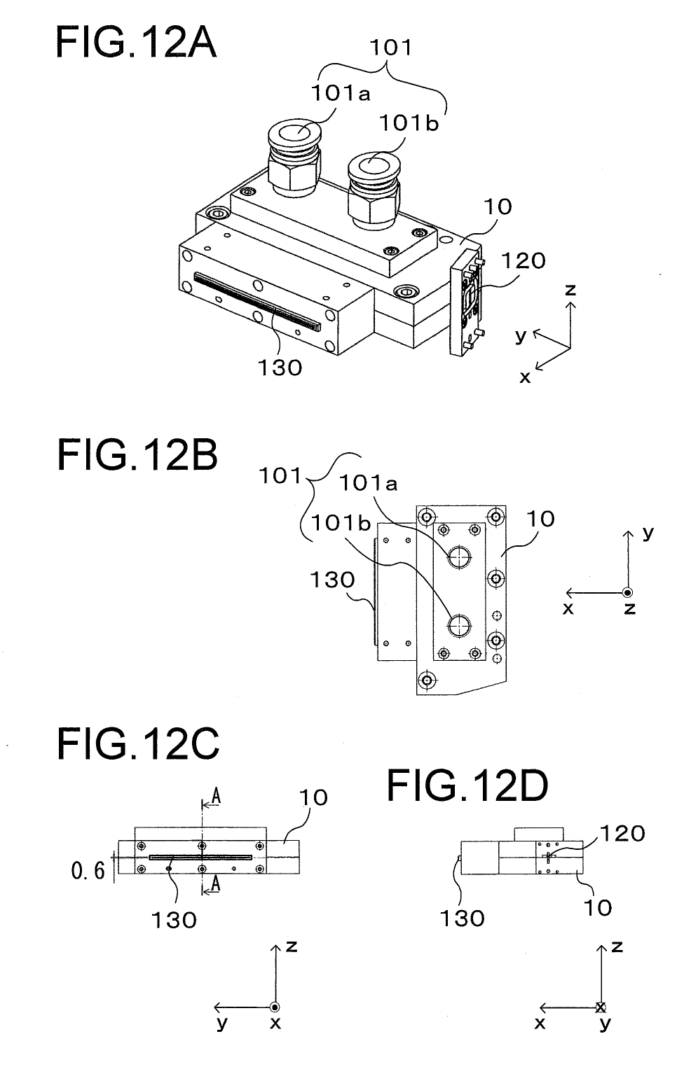

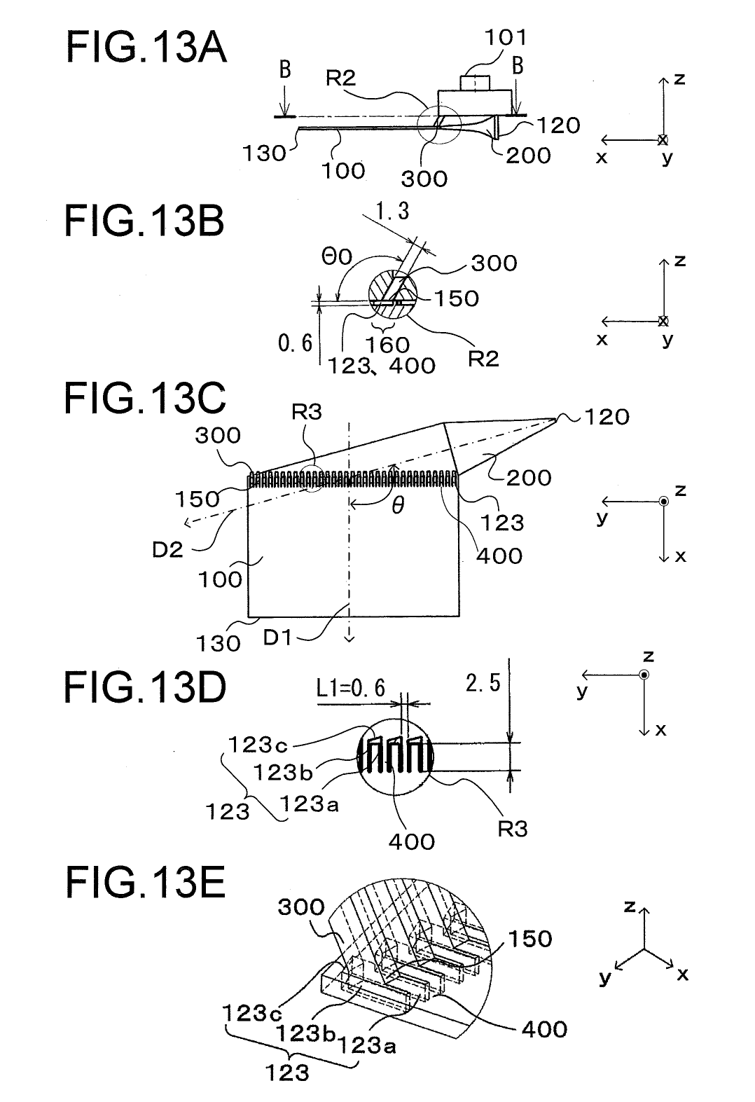

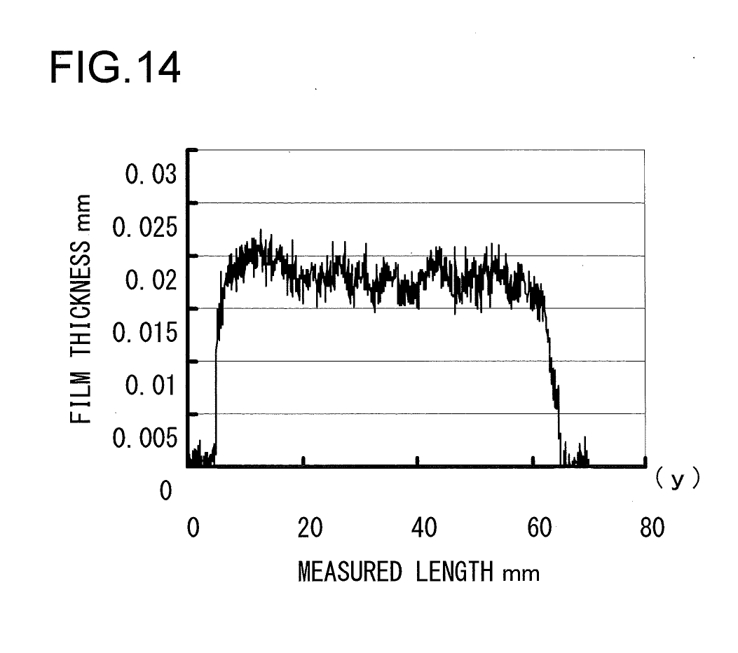

An example of dimensions of each part of the jet nozzle 10 according to the first embodiment will be indicated with reference to FIG. 12A to FIG. 12D, FIG. 13A to FIG. 13E, and FIG. 14. Incidentally, FIG. 12A to FIG. 12D are external views of the jet nozzle 10 in Example 1; FIG. 12A is an external perspective view; FIG. 12B is a parts assembly figure as viewed from the z-axis positive side of FIG. 12A; FIG. 12C is a parts assembly figure as viewed from the x-axis positive side of FIG. 12B; and FIG. 12D is a parts assembly figure as viewed from the y-axis negative side of FIG. 12B. FIG. 13A to FIG. 13E are explanatory figures of the flow channels of the jet nozzle 10; FIG. 13A is a cross-sectional view illustrating the flow channels as taken along section A-A in FIG. 12C; FIG. 13B is an enlarged cross-sectional view illustrating region R2 indicated with a broken line in FIG. 13A; FIG. 13C is a plan view illustrating the flow channels taken along section B-B in FIG. 13A; and FIG. 13D is an enlarged cross-sectional view of region R3 indicated with a broken line in FIG. 13C. FIG. 13E is an enlarged perspective view illustrating an area in the vicinity of the flow diverging region 160 of the jet nozzle 10.

Long-side length of the jet opening 130 (along the y-axis direction): 60 mm

Short-side length of the jet opening 130 (along the z-axis direction): 0.6 mm

x-axis length of a salient portion 123: 2.5 mm

y-axis-direction distance L1 between adjacent salient portions 123: 0.6 mm

Long-side length of the third flow channel 300: 1.3 mm

Short-side length of the third flow channel 300 (along the y-axis direction): 0.8 mm

x-axis length (from the end portion of the salient portion 123 to the jet opening 130) of the first flow channel: 37 mm

Angle θ formed by D1 and D2: 115 degrees

Incidentally, in Example 1, the gas introduction opening 101 is composed of a first introduction opening 101a and a second introduction opening 101b, and the acceleration gas from the first introduction opening 101 and the acceleration gas from the second introduction opening 101b merge with each other and then they are supplied to the third flow channel 300. A flow channel section taken along a plane perpendicular to the jetting direction D1 of the first flow channel 100 remains a constant cross-sectional area regardless of its x-axis direction position.

FIG. 14 illustrates the measured value of thickness of a film, which is obtained by jetting the solid particles from the jet opening 130 onto the electrode substrate (copper foil) related to the position in the y-axis direction; and the vertical axis represents the thickness of the formed film. Film forming conditions at this case are as follows.

Solid particles: Cu—Si composite particles

Mean particle diameter of the solid particles: 10 [μm]

Velocity at the end of the first flow channel: 280 [m/sec]

Pressure inside the first flow channel: 0.3 [MPa]

Pressure of the acceleration gas at the gas introduction opening: 0.5 [MPa]

Temperature of the substrate: 150 [° C.]

Supplied amount rate of the acceleration gas: 320 [l/min]

Relative movement speed of the jet nozzle 10 and the electrode substrate: 1 [mm/sec]

Incidentally, the above-mentioned supplied amount rate of the acceleration gas is a total amount of the acceleration gas introduced from the first introduction opening 101a and from the second introduction opening 101b.

The solid particles jetted from the jet opening 130 form a substantially uniform film thickness within a wide range along the y-axis direction of the electrode substrate as illustrated in FIG. 14. Therefore, it is shown that the solid particles are diffused substantially uniformly along the y-axis direction and jetted from the jet opening 130 by setting the flow channels of the jet nozzle 10 as indicated in Example 1. The following effects can be obtained by using the jet processing device 1 according to the aforementioned first embodiment.

(1) The first flow channel 100 extends along the jetting direction D1 to the jet opening 130 and the second flow channel 200 joins the first flow channel 100 at the particle confluence opening 140 provided on the narrow wall surface of the first flow channel 100 in the confluence direction D2 at the predetermined angle θ with the jetting direction D1, and makes the solid particles introduced from the particle introduction opening 120 flow to the first flow channel 100. The third flow channel 300 accelerates the solid particles by jetting the acceleration gas introduced from the gas introduction opening 101 into the first flow channel 100. In the first flow channel 100, the flow diverging region 160, which is composed of the plurality of flow diverging channels 400 arranged in a direction intersecting with the jetting direction D1, is provided on the opposite side of the jet opening 130 and. Because of the above-described structure, when the flowing direction of the solid particles from the second flow channel 200 changes from the confluence direction D2 to the jetting direction D1, the solid particles can be dispersed within the fluid mixture by means of the flow diverging region 160, diffused substantially uniformly in the fluid mixture within the first flow channel 100, and jetted from the jet opening 130. As a result, the film thickness of a deposited layer of the solid particles adhered to, for example, the electrode substrate can be made substantially uniform along the extending direction (the y-axis direction) of the jet opening 130. Therefore, since a desired film thickness can be obtained within a wide range along the y-axis direction, productivity of the cell component is improved. Furthermore, because of the aforementioned structure, the solid particles are diffused and the velocity of the solid particles jetted from the jet opening 130 is equalized, thereby making it possible to prevent the possibility that the solid particles in fast velocity collide with and scale the already formed deposited layer.

(2) The plurality of acceleration gas confluence openings 150 are arranged in a direction intersecting with the jetting direction D1. As a result, a substantially uniform flow rate of the fluid mixture of the solid particles and the gas can be obtained along the direction intersecting with the jetting direction D1.

(3) The acceleration gas confluence openings 150 are provided in the vicinity of the flow diverging region 160. As a result, the solid particles dispersed in the flow diverging region 160 can be accelerated in the x-axis positive direction.

(4) Each acceleration gas confluence opening 150 is provided corresponding to each of the plurality of flow diverging channels 400. Therefore, a flow rate required for the film forming processing can be obtained by drawing in and accelerating the solid particles flowing in the flow diverging channels 400 in the x-axis positive direction.

(5) The flow diverging region 160 is provided in the vicinity of the particle confluence opening 140. As a result, it is possible to promote diffusion of the solid particles, which have flown from the second flow channel 200, in the fluid mixture.

(6) When the plurality of flow diverging channels 400 are aligned linearly in a direction perpendicular to the jetting direction D1, this alignment contributes to further uniformity of the flow rate of the fluid mixture of the solid particles and the gas along the y-axis direction.

(7) The plurality of salient portions 123 are arranged along the direction intersecting with the jetting direction D1, that is, along the y-axis direction and the plurality of flow diverging channels 400 extend along the jetting direction D1 between the plurality of salient portions 123. Therefore, the solid particles supplied from the particle introduction opening 120 can be dispersed and a travelling direction of the solid particles can be adjusted to the x-axis positive side.

(8) As the solid particles flowing from the second flow channel 200 collide with the plurality of salient portions 123, the plurality of salient portions 123 cause the solid particles to be dispersed. As a result, the solid particles can be diffused substantially uniformly in the fluid mixture within the first flow channel 100 and jetted from the jet opening 130.

(9) Each acceleration gas confluence opening 150 is provided corresponding to each of the plurality of the salient portions 123. Specifically, the acceleration gas confluence opening 150 is provided in a region surrounded by the wall portions 123a and 123b and the connecting wall portion 123c of each salient portion 123. As a result, the ejector effect is caused by the acceleration gas in the vicinity of the acceleration gas confluence openings 150 and the solid particles are drawn into the x-axis positive direction in the first flow channel 100, so that the solid particles which have collided with the salient portions 123 and have been dispersed can be accelerated towards the x-axis positive direction.

(10) The particle introduction opening 120 is of a rectangular shape having the longitudinal direction and the transverse direction, and the length of the longitudinal direction (y-axis direction) of the jet opening 130 is longer than the length of the transverse direction of the particle introduction opening 120, that is, the length of the longitudinal direction of the jet opening 130 is configured to be larger than one time of the length of the transverse direction of the particle introduction opening 120. As a result, it is possible to obtain a wide range within which the film with a substantially uniform thickness can be formed on, for example, the electrode substrate by jetting the solid particles.

(11) The jet processing device 1 includes the jet nozzle 10 and the solid particle supply unit 11 which introduces the solid particles via the particle introduction opening 120 into the second flow channel 200 formed in the jet nozzle 10. Therefore, since the solid particles which are diffused uniformly can be jetted from the flat shaped jet opening 130, it makes possible to process in a large area per jetting, productivity of products can be improved.

(12) Regarding the jet processing method, the fluid mixture of the solid particles and the gas is jetted from the jet opening 130 of the jet processing device 1 and the solid particles are made to collide with the substrate located opposite the jet opening 130 and are adhered to the surface to be processed of the substrate. Therefore, a substantially uniform film thickness can be formed in a large area, so that high-quality products can be manufactured at high productivity.

The jet processing device 1 according to the first embodiment described above can be modified as follows.

The acceleration gas confluence opening 150 is not limited to be provided in the region surrounded by the wall portions 123a and 123b and the connecting wall portion 123c of each salient portion 123. The acceleration gas confluence opening 150 may be provided in the vicinity of each salient portion 123 or in the vicinity of a certain salient portion 123 with respect to a certain number of salient portions 123 as long as the necessary flow rate of the solid particles at the jet opening 130 can be obtained. The acceleration gas confluence opening 150 may be provided in the vicinity of at least one salient portion 123 or several salient portions 123.

### Second Embodiment

A jet processing device according to a second embodiment of the present invention will be explained with reference to drawings. In the following explanation, the same reference numerals as those used in the first embodiment are assigned to the same components as those of the first embodiment and the difference between the first embodiment and the second embodiment will be mainly explained. Matters which will not be particularly explained are the same as those in the first embodiment. The difference between this embodiment and the first embodiment is that the first flow channel is formed with a step in the z-axis direction.

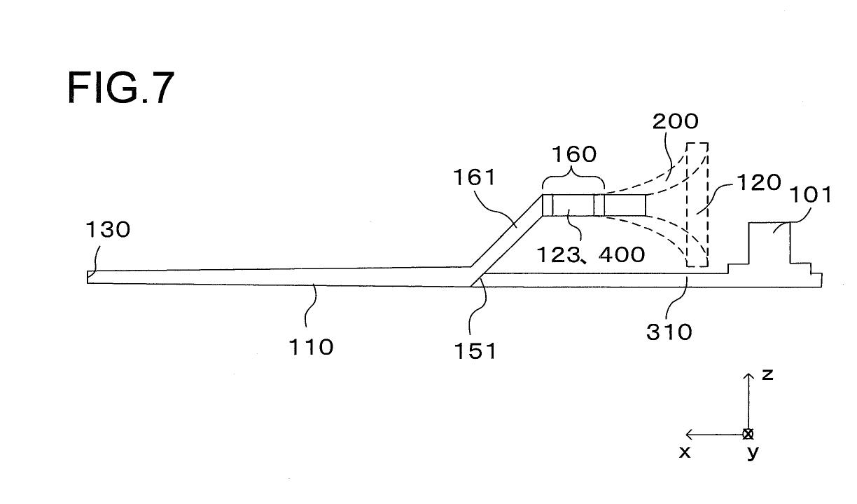

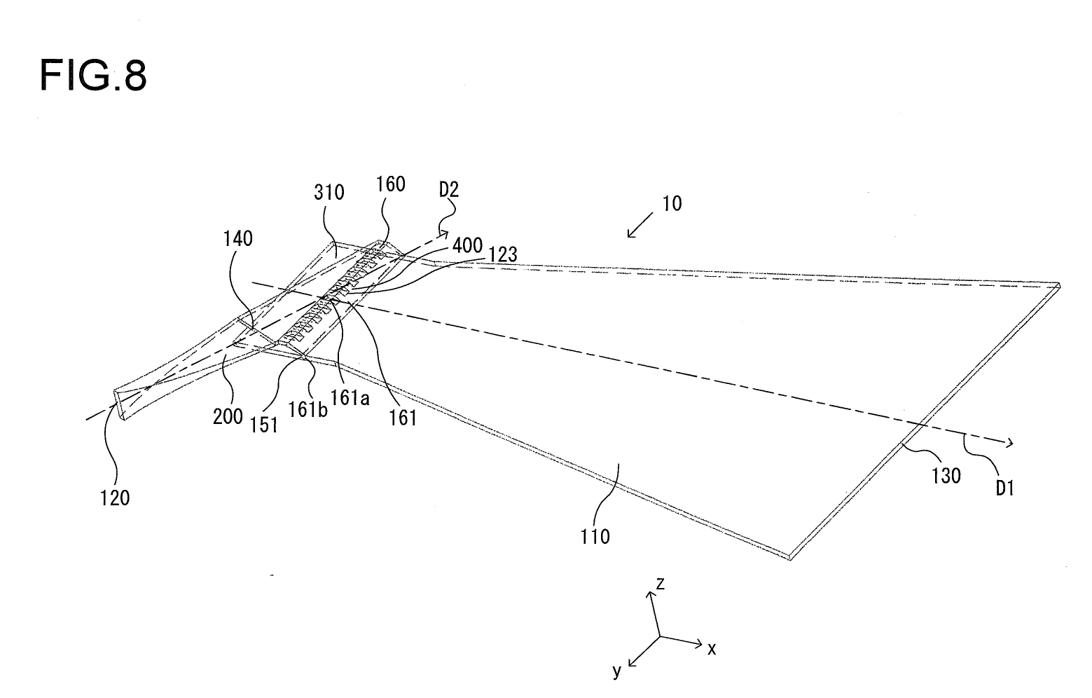

FIG. 7 is a cross-sectional view of flow channels in the jet nozzle 10 of the jet processing device 1 according to the second embodiment and illustrates a section taken along line B-B in FIG. 1B. FIG. 8 is a perspective view of the flow channels inside the jet nozzle 10. Incidentally, for the convenience of explanation, FIG. 7 schematically illustrates the section of the flow channels as viewed from the y-axis negative side. Furthermore, regarding FIG. 7 and FIG. 8 as well, the coordinate system represented by the x-axis, the y-axis, and the z-axis are set as indicated in the drawings.

In the jet nozzle 10 according to the second embodiment, a first flow channel 101 has a step in the z-axis direction as illustrated in FIG. 7 and FIG. 8. The particle confluence opening 140 of the first flow channel 110 is provided on the z-axis positive side relative to the jet opening 130. An inclined region 161 is formed in the first flow channel 110 on the x-axis positive side relative to the flow diverging region 160. The inclined region 161 is a region from an end portion 161a to an end portion 161b as illustrated in FIG. 8. The inclined region 161 is inclined from the end portion 161a to the end portion 161b so that advancing towards the z-axis negative direction in accordance with advancing towards the x-axis positive side.

The first flow channel 110 is provided with an acceleration gas confluence opening 151 on the wide wall surface in the vicinity of the end portion 161b of the inclined region 161 in a direction intersecting with the jetting direction D1. A third flow channel 310 extending from the x-axis negative side connects to the first flow channel 110 as illustrated in FIGS. 7 and 8. Incidentally, FIGS. 7 and 8 illustrate an example in which the range the first flow channel 110 from the end portion 161b to the jet opening 130 and the third flow channel 310 are provided on the same plane relative to the z-axis direction; however, the present invention is not limited to this example and a case in which the first flow channel 110 join the third flow channel 310 with a step in the z-axis direction may also be included as an embodiment of the present invention.

Since the acceleration gas confluence opening 151 is provided in the inclined region 161 as described above, the acceleration gas confluence openings 150 are not provided in the vicinity of the salient portions 123 which protrude in the flow diverging region 160 in the second embodiment. Gas such as He, N₂, Ar, air, or the like (acceleration gas) is supplied from a gas supply source (not illustrated in the drawing) via, for example, a tube to an end of the first flow channel 110 on the x-axis negative side.

The acceleration gas from the third flow channel 310 is introduced to the first flow channel 110 via the acceleration gas confluence opening 151 provided on the wide wall surface and flows in the x-axis positive direction as described above. Therefore, the fluid mixture of the solid particles and the gas which is supplied from the solid particle supply unit 11 and flows through the second flow channel 200 is drawn into the first flow channel 110 by the negative pressure caused by the ejector effect of the acceleration gas in the vicinity of the inclined region 161. The fluid mixture which is drawn into the first flow channel 110 flows in the x-axis positive direction through the first flow channel 110 and the fluid mixture of the solid particles and the gas is jetted from the jet opening 130 towards the electrode substrate as explained in the first embodiment.

The jet processing device 1 according to the aforementioned second embodiment can obtain the same effects as those which can be obtained by the jet processing device 1 according to the first embodiment. Particularly in this embodiment, the first flow channel 110 includes the inclined region 161 and is thereby formed with the step in the z-axis direction. As a result, the negative pressure can be caused in the vicinity of the inclined region 161 and the fluid mixture of the solid particles and the gas which flows through the second flow channel 200 can be drawn into the x-axis positive direction of the first flow channel 101 by the ejector effect.

### Example 2

An example of dimensions of each part of the jet nozzle 10 according to the second embodiment will be indicated below.

Long-side length of the particle introduction opening 120 (along the z-axis direction): 6.8 mm

Short-side length of the particle introduction opening 120: 1 mm

Long-side of the jet opening 130 (along the y-axis direction): 60 mm

Short-side length of the jet opening 130 (along the z-axis direction): 0.7 mm

Long-side length of the acceleration gas confluence opening 151 (along the y-axis direction): 22 mm

y-axis direction width of the flow diverging channel 400: 1.0 mm

x-axis width of the flow diverging channel 400: 2.1 mm

x-axis length (from the end portion of the salient portion 123 to the jet opening 130) of the first flow channel: 86 mm

Angle θ formed by D1 and D2: 112 degrees

Regarding the flow diverging region 160, the long side (along the y-axis direction) of its flow channel section taken along a plane perpendicular to the x-axis at the end of the x-axis negative side is 22 mm and its short side (along the z-axis direction) is 0.5 mm.

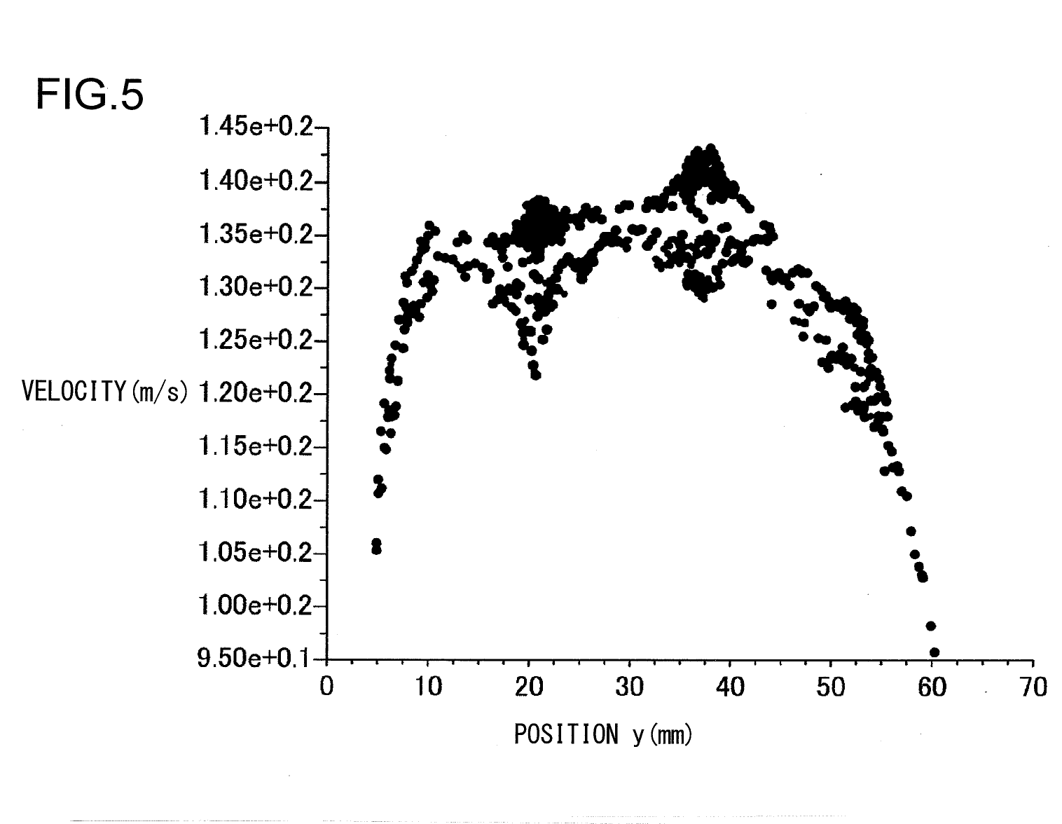

FIG. 5 illustrates simulation results about the jet nozzle 10 in Example 2 described above. Simulation conditions are as follows.

(1) Gas in the first flow channel 110: compressible and turbulent flow field
(2) Velocity at the end of the first flow channel 110: 100 [m/sec] to 360 [m/sec]
(3) Pressure in the first flow channel 110: 0.1 [Mpa] to 1.0 [Mpa]
(4) Solid particles: Cu—Si composite particles
(5) Mean particle diameter of the solid particles: 10 [μm]

### (6) Gas: N₂

(7) Used formulas: Navier-Stokes equation, turbulence models (standard k-ε model and wall surface function), a particle motion equation (Lagrangian function), and resistance between particles (Stokes resistance in Cunningham correlation)

Incidentally, it is decided that the velocity of the solid particles may exceed 360 m/sec mentioned above in the vicinity of the jet opening 130 (that is, at the downstream end of the second flow channel 200) due to effects of compression and expansion, and the like.

FIG. 5 illustrates the relationship between a flow rate of the fluid mixture jetted from the jet opening 130 and the position in the y-axis direction; and the vertical axis represents the flow rate of the fluid mixture. The flow rate is almost constant within a wide range along the y-axis direction of the jet opening 130 as illustrated in FIG. 5.

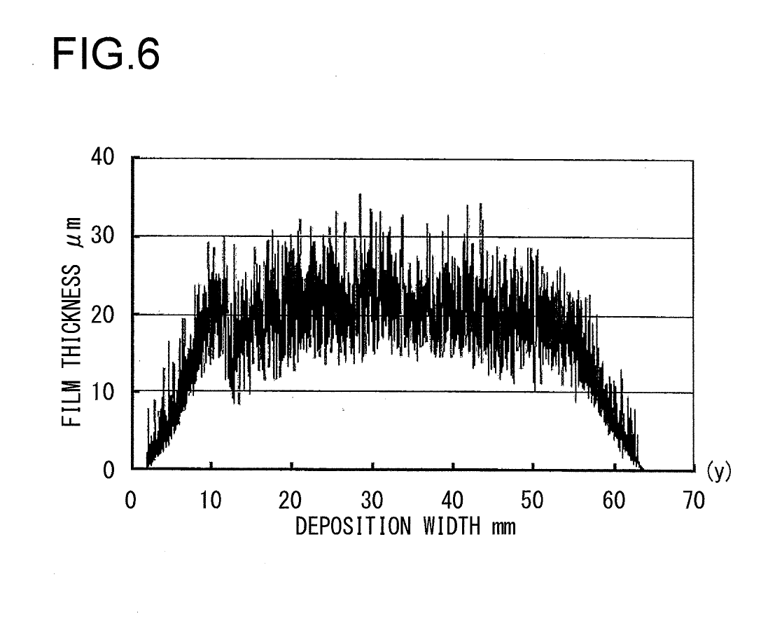

FIG. 6 illustrates the measured value of thickness of a film, which is formed by actually jetting the solid particles from the jet opening 130 onto the electrode substrate (copper foil) related to the position in the y-axis direction; and the vertical axis represents the thickness of the formed film. Film forming conditions at this case are as follows.

Solid particles: Cu—Si composite particles

Mean particle diameter of the solid particle: 10 [μm]

Velocity at the end of the first flow channel: 150 [m/sec]

Pressure inside the first flow channel: 0.3 [MPa]

Temperature of the substrate: 150 [° C.]

Distribution of the film thickness along the y-axis direction as illustrated in FIG. 6 corresponds to the simulation results of the flow rate of the fluid mixture from the jet opening 130 as illustrated in FIG. 5. That is, the solid particles jetted from the jet opening 130 form a substantially uniform film thickness within a wide range along the y-axis direction of the electrode substrate.

Diffusion of the solid particles is promoted by setting the flow channels of the jet nozzle 10 as indicated in Example 2 described above. In the case of the example, the short-side length of the flow channel section taken along a plane perpendicular to the confluence direction D2 at the particle confluence opening 140 where the second flow channel 200 connects to the first flow channel 110 is shorter than the z-axis direction length at the particle introduction opening 120. As a result, the degree of motion freedom of the solid particles in the z-axis direction decreases; and on the other hand, the degree of motion freedom at the flow channel section in the direction perpendicular to the z-axis increases. As a result, the solid particles which have flown into the first flow channel 110 become easily diffused in the jetting direction D1. Furthermore, the solid particles are diffused substantially uniformly in the y-axis direction within the first flow channel 110 by setting the flow channels of the jet nozzle 10 as indicated in the example. The jet processing device 1 according to the second embodiment explained above can be modified as follows.

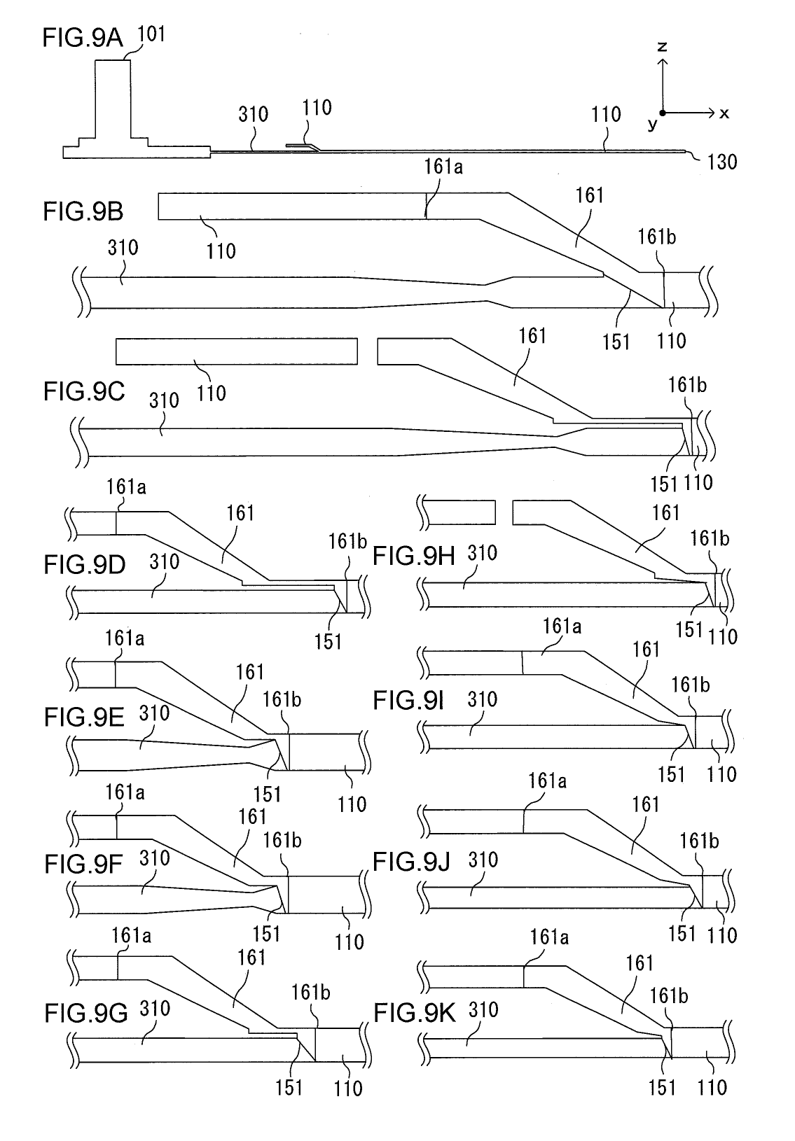

(1) Various shapes as illustrated in FIG. 9A to FIG. 9K can be adapted as a cross-sectional shape of the inclined region 161 near the end portion 161b. In this case, the shape can be changed to further enhance the effect of drawing the fluid mixture in the x-axis positive direction according to materials of the solid particles by using simulations and experiments. Incidentally, FIG. 9A is a cross-sectional view taken along A-A in FIG. 1B and FIG. 9B to FIG. 9K are enlarged views of an area in the vicinity of an inclined coupling flow channel 311.

(2) Instead of the structure in which the cross-sectional area of the flow channel section taken along the plane perpendicular to the jetting direction D1 of the first flow channel 110 gradually and continuously increases towards the jet opening 130, a structure having the same cross-sectional area along the plane perpendicular to the jetting direction D may be used. Furthermore, instead of the flow channel section of the first flow channel 110 whose y-axis direction length, that is, the long-side length continuously increases to both the y-axis positive direction and the y-axis negative direction, the flow channel section of the first flow channel 110 whose y-axis direction length continuously increases to either the y-axis positive direction or to the y-axis negative direction may be used. Instead of the flow channel 110 in which the cross-section area thereof in the plane perpendicular to the jetting direction D1 continuously increases towards the jet opening 130, the cross-sectional area of the first flow channel 110 increases in a stepwise manner may be used. However, even in each of the above-mentioned cases, the length of the longitudinal direction of the jet opening 130 is configured to become longer than the length of the transverse direction of the particle introduction opening 120, that is, the length of the longitudinal direction of the jet opening 130 is configured to be larger than one time of the length of the transverse direction of the particle introduction opening 120.

The following variations are also within the range of the present invention and one or more of the variations can be combined with the first embodiment and/or the second embodiment explained earlier.

(1) The wall portions 123a and 123b of the salient portion 123 are not limited to those provided along the jetting direction D1. The wall portions 123a and 123b may be of, for example, curved shape as long as they can introduces the dispersed solid particles to the jetting direction D1. The salient portion 123 may have a dense structure instead of a U-shape.

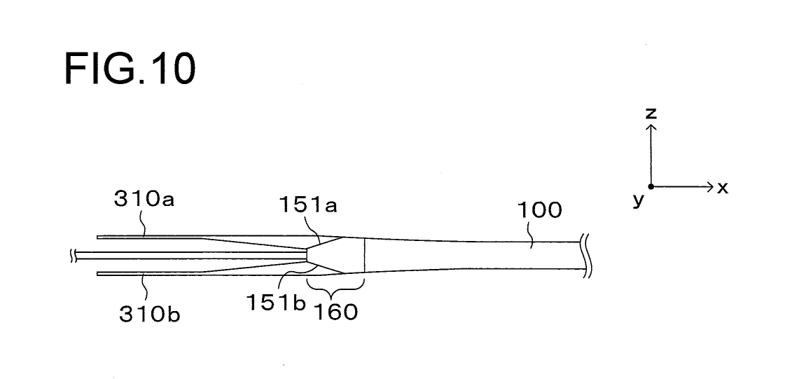

(2) A plurality of acceleration gas introduction ports may be provided in the vicinity of the flow diverging region 160 of the first flow channel 100 as illustrated in FIG. 10. FIG. 10 illustrates an example of the structure in which the acceleration gas introduction ports are provided at two positions, that is, on an upper-side wide wall surface (the z-axis positive side) and a lower-side wide wall surface (the z-axis negative side) in the vicinity of the flow diverging region 160 of the first flow channel 100. In this case, the acceleration gas from the upper-side wide wall surface collides with, and joins with, the acceleration gas from the lower-side wide wall surface in the vicinity of the flow diverging region 160 of the first flow channel 100. As a result, the solid particles are dispersed well.

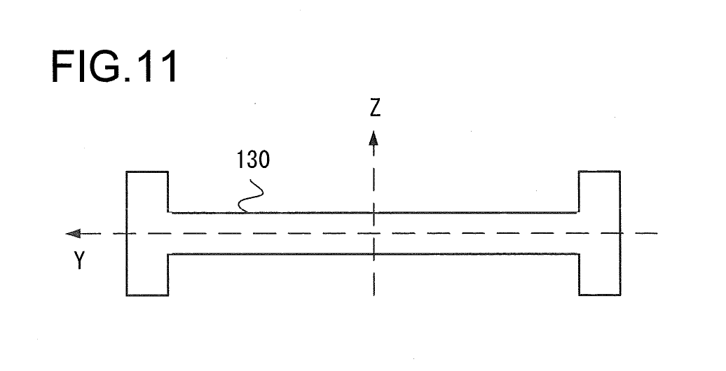

(3) The shape of the jet opening 130 is not limited to the rectangular. For example, the z-axis direction length at both of the y-axis direction ends of the jet opening 130 may be formed to be longer than the z-axis direction length of a central portion of the jet opening 130 so that a cross-section of the jet opening 130 is an “H-shape” as illustrated in FIG. 11. As a result, a reduction of the flow rate of the fluid mixture due to, for example, boundary regions at both ends of the jet opening 130 can be suppressed and the range of a substantially uniform thickness of the film formed on, for example, the electrode substrate can be expanded. Incidentally, the jet opening 130 may be of a shape whose z-axis direction length at least one of both the ends of the jet opening 130 is longer than the z-axis direction length of a central portion of the jet opening 130. Furthermore, the shape of both ends of the jet opening 130 is not limited to the rectangular as illustrated in FIG. 11.

(4) Instead of forming the electrode material film by the PJD (Powder Jet Deposition) method using the jet processing device 1, various methods such as a cold spray method, an aerosol deposition method, thermal spraying, or the like can be used.

(5) It is not limited that the film is formed by jetting the solid particles from the jet processing device 1 onto the electrode substrate and various film forming may be applicable by using the solid particles jetted onto the surface of the substrate to be processed. For example, an electric wiring layer may be formed by using the solid particles jetted onto the surface of the substrate to be processed. Furthermore, the jet processing device 1 may be a removal processing device that performs removal processing by using the solid particles jetted onto the surface of the substrate to be processed. The jet processing device 1 may be equipped with, for example, a substrate supply mechanism, a temperature control mechanism, and a solid particle recovery mechanism in addition to the jet nozzle 10 and the solid particle supply unit 11.

(6) The electrode material may be a known electrode material for a primary cell.

(7) The dimensions and materials of each component of the jet nozzle 10 are not limited to those in the embodiments. The dimensions and materials of each component may be decided according to the materials and particle diameter of the solid particles so that the thickness of the film formed of the solid particles jetted from the jet opening 130 and adhered to, for example, the electrode substrate can be made substantially uniform along the extending direction (the y-axis direction) of the jet opening 130.

The present invention is not limited to the above-described embodiments and variations unless they impair the characteristics of the present invention. Other aspects that can be thought of within the scope of technical ideas of the present invention are also included in the scope of the present invention.

What is claimed is:

1. A jet nozzle comprising:
a jet opening through which a fluid mixture of particles and gas is jetted;
a first flow channel extending along a first direction to the jet opening;
a flow diverging region located in the first flow channel at opposite the jet opening and comprises a plurality of flow diverging channels arranged in a direction intersecting with the first direction;
a second flow channel that makes the particles join in the flow diverging region in a second direction which is at a predetermined angle to the first direction; and
a third flow channel through which the gas is jetted to the first flow channel.

2. The jet nozzle according to claim 1, further comprising:
a particle introduction opening through which the particles are introduced; and
a gas introduction opening through which the gas for accelerating the particles is introduced, wherein:
the first flow channel comprises a wide wall surface, which is a wall surface including a longitudinal direction of a flow channel section perpendicular to the first direction, and a narrow wall surface which is a wall surface including a direction intersecting with the longitudinal direction;
the second flow channel makes the particles, which are introduced from the particle introduction opening, join in the flow diverging region; and
the third flow channel jets the gas, which is introduced from the gas introduction opening, through an acceleration gas confluence opening towards the first flow channel.

3. The jet nozzle according to claim 2, wherein:
a plural number of the acceleration gas confluence opening is arranged to intersect with the first direction.

4. The jet nozzle according to claim 2, wherein:
the acceleration gas confluence opening is provided near the flow diverging region.

5. The jet nozzle according to claim 2, wherein:
the acceleration gas confluence opening is provided corresponding to each of the plurality of flow diverging channels.

6. The jet nozzle according to claim 2, wherein:
the particles introduced from the second flow channel join in the first flow channel through a particle confluence opening; and
the flow diverging region is provided in the vicinity of the particle confluence opening.

7. The jet nozzle according to claim 3, wherein:
the plurality of flow diverging channels are arranged linearly in a direction perpendicular to the first direction.

8. The jet nozzle according to claim 2, wherein:
a plurality of salient portions having a width in a direction intersecting with the first direction and protruding from the wide wall surface are arranged in a direction intersecting with the first direction in the flow diverging region; and
each of the plurality of flow diverging channels extends between the salient portions.

9. The jet nozzle according to claim 8, wherein:
the plurality of salient portions are ones which the particles flowing from the second flow channel collide with and diverge at.

10. The jet nozzle according to claim 2, wherein:
the acceleration gas confluence opening introduces the gas and causes an ejector effect to make the particles drawn from the second flow channel into the first flow channel.

11. The jet nozzle according to claim 2, wherein:
the particle introduction opening has a rectangular shape with a longitudinal direction and a transverse direction; and
a length of the longitudinal direction of the jet opening is predetermined times as long as a length of the transverse direction of the particle introduction opening.

12. The jet nozzle according to claim 2, wherein:
the predetermined angle is larger than 90 degrees.

13. A jet processing device comprising:
the jet nozzle according to claim 2; and
a particle supply unit that supplies the particles via the particle introduction opening to the second flow channel of the jet nozzle.

14. A processing method comprising:
jetting the fluid mixture of the particles and the gas from the jet opening of the jet nozzle in the jet processing device according to claim 13; and
making the particles collide with a substrate located opposite the jet opening.

15. A cell component manufacturing method comprising:
making the particles collide with an electrode substrate provided as the substrate by the processing method according to claim 14; and
forming an electrode material film on the electrode substrate.

16. A secondary cell comprising the electrode material film formed by the cell component manufacturing method according to claim 15 on an electrode.
